(19) United States
(12) Patent Application Publication
(10) Pub. No.: US 2012/0185790 A1
(43) Pub. Date: Jul. 19, 2012

(54) METHOD FOR MANAGING CONTENT IN A PLURALITY OF DEVICES USING A DISPLAY APPARATUS

(75) Inventors: Joo-yoon BAE, Seoul (KR); Ji-hoon Choi, Seoul (KR)

(73) Assignee: Samsung Electronics Co., Ltd., Suwon-si (KR)

(21) Appl. No.: 13/323,188

(22) Filed: Dec. 12, 2011

(30) Foreign Application Priority Data
Jan. 14, 2011 (KR) 10-2011-0004274

(51) Int. Cl. G06F 3/048

(52) U.S. Cl. 715/769

(57) ABSTRACT

A content managing method using a display apparatus includes, if a plurality of external apparatuses are connected to the display apparatus, displaying a plurality of UIs including an icon of respective external apparatuses in an image form corresponding to a shape of respective external apparatuses, and if a user operation is performed on a plurality of UIs, moving content between the plurality of external apparatuses according to the user operation.

### PRIORITY

This application claims priority under 35 U.S.C. §119(a) to Korean Patent Application No. 2011-0004274, which was filed in the Korean Intellectual Property Office on Jan. 14, 2011, the entire disclosure of which is incorporated herein by reference.

### BACKGROUND OF THE INVENTION

1. Field of the Invention

The present invention relates generally to a method for managing content using a display apparatus, and more particularly, to a method for managing content to move or edit content stored in an external apparatus connected to a display apparatus and a display apparatus using the same.

2. Description of the Related Art

A multi-media apparatus stores various content in a single apparatus. Generally, a user connects an apparatus to a Personal Computer (PC) and executes a content management program to manage content stored in the apparatus. Subsequently, the user inputs a command to store the content stored in the apparatus in the PC. If content stored in the apparatus is modified or changed through the content management program, the user needs to input an additional command to reflect this change in the apparatus.

Conventional content management programs are provided through explorer window views regardless of the corresponding apparatus. Therefore, if a plurality of explorer windows are provided, it is difficult for a user to figure out which apparatus stores content to be moved or edited corresponding to which window. In addition, a user needs to input several commands to move or edit content, which causes inconvenience. Accordingly, there is a need for a method which allows a user to easily and intuitively manage content.

### SUMMARY OF THE INVENTION

Accordingly, the present invention has been made to solve the above-mentioned problems occurring in the prior art, and the present invention provides a method for managing content by displaying a UI corresponding to a shape of an external apparatus connected to a display apparatus and moving content between external apparatuses and editing content stored in external apparatuses through a user operation on the displayed UI, and a display apparatus using the same.

According to an aspect of the present invention, there is provided a method for managing content using a display apparatus, which includes, if a plurality of external apparatuses are connected to the display apparatus, displaying a plurality of UIs including an icon of respective external apparatuses in an image form corresponding to a shape of respective external apparatuses, and if a user operation is performed on the plurality of UIs, moving content between the plurality of external apparatuses according to the user operation.

According to another aspect of the present invention, there is provided a display apparatus, which includes a communication interface unit which is connected to at least one external apparatus and transmits and receives content, a display unit which, if a plurality of external apparatuses are connected to the interface, displaying a plurality of UIs including icons of respective external apparatuses in an image form corresponding to shapes of respective external apparatuses, an input unit which receives a user operation, and a control unit which, if a user operation regarding the plurality of UIs is input, controls to move content between the plurality of external apparatuses according to the user operation.

### BRIEF DESCRIPTION OF THE DRAWINGS

The above and other features, aspects and advantages of the present invention will be more apparent from the following detailed description taken in conjunction with the accompanying drawings, in which:

FIG. 1 is a diagram illustrating the components of a system for implementing the content management method according to an embodiment of the present invention;

FIG. 2 is a block diagram illustrating a structure of a display apparatus 100 according to an embodiment of the present invention;

FIG. 3 is a diagram illustrating a structure of a display apparatus 100 in greater detail according to an embodiment of the present invention;

FIGS. 4A and 4B are diagrams illustrating a UI displayed on a display apparatus in greater detail according to an embodiment of the present invention;

FIGS. 5A to 5D are diagrams illustrating a display apparatus moving content between external apparatuses according to an embodiment of the present invention;

FIGS. 6A and 6B are diagrams illustrating a method through which a display apparatus edits content stored in an external apparatus according to an embodiment of the present invention; and

FIG. 7 is a flowchart illustrating a method for managing content of an external apparatus according to an embodiment of the present invention.

### DETAILED DESCRIPTION OF EMBODIMENTS OF THE PRESENT INVENTION

Hereinafter, the present invention will be described in greater detail with reference to the accompanying drawings, in which aspects of the present invention are illustrated. In the following description, like drawing reference numerals are used for the like elements, throughout the drawings. While the embodiments are described with detailed construction and elements to assist in a comprehensive understanding of the various embodiments, the embodiments can be implemented without those specific details. Also, well-known functions or constructions may be omitted to avoid obscuring the description with unnecessary detail.

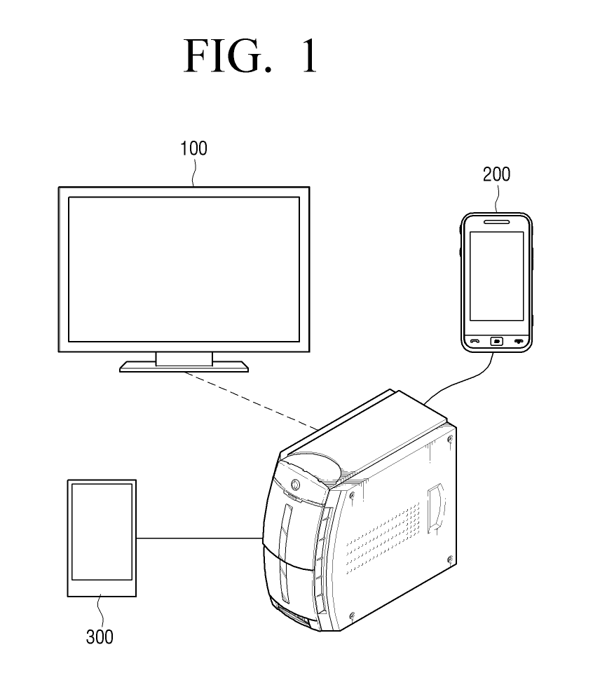

FIG. 1 is a diagram illustrating the components of a system for implementing a content management method according to an embodiment of the present invention. Referring to FIG. 1, a display apparatus 100 is connected to a first external apparatus 200 and a second external apparatus 300 and may manage content stored in the first and the second external apparatuses 200, 300.

Specifically, the display apparatus 100 displays a User Interface (UI) corresponding to the first and the second external apparatuses 200, 300 respectively, controls movement of content between the first external apparatus 200 and the second external apparatus 300 based on user command, and controls editing content stored in the first and the second external apparatuses 200, 300 respectively. Herein, editing includes changing, modifying, adding and deleting content.

The display apparatus 100 represents an apparatus capable of transmitting and receiving content to and from an external apparatus and outputting an image and may be implemented as a PC. However, the display apparatus 100 is not limited thereto and may be any apparatus, which is capable of transmitting and receiving content as being connected to an external apparatus. For example, the display apparatus 100 may be implemented as a digital TV or a notebook computer.

The first and the second external apparatuses 200, 300 are apparatuses capable of storing and outputting content and may be implemented as a mobile phone, an MP3 player, a PMP digital camera, a PDA, or a navigator. Herein, the content may be various data stored in a display apparatus or an external apparatus, and may include moving image, image, text, application, sound data, slide show of a photo, memo, message, and telephone book according to the characteristics of the external apparatuses 200, 300.

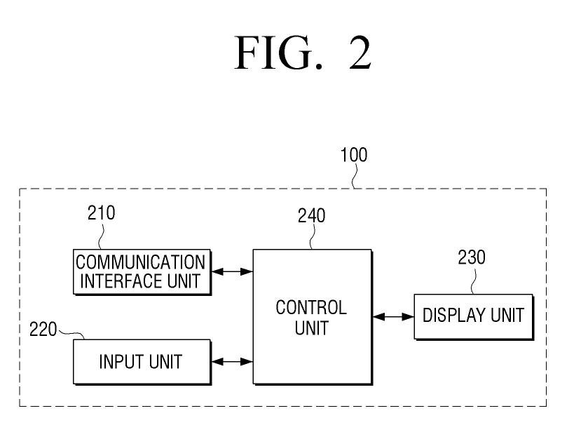

FIG. 2 is a block diagram illustrating a structure of the display apparatus 100 according to an embodiment of the present invention.

Referring to FIG. 2, the display apparatus 100 comprises a communication interface 210, an input unit 220, a display unit 230, and a control unit 240.

The communication interface 210 is connected to an external apparatus via cable or wirelessly and transmit and receive various content to and from the external apparatus. As described above, the content may be various data such as moving image, image, text, application, sound data, slide show of a photo, memo, message, and telephone book.

Specifically, the communication interface 210 may receive content stored in an external apparatus based on user command and transmit content received from an external apparatus or content stored in the display apparatus 100 to another external apparatus. In addition, the communication interface 210 may receive various information regarding an external apparatus from the external apparatus. Herein, the various information may include content information stored in an external apparatus, information regarding a product type of an external apparatus, and information regarding a manufacturer.

The input unit 220 receives input of a user operation, such as selecting an icon or a thumbnail image of content included in a UI corresponding to an external apparatus or a user operation of storing or dragging a selected icon and thumbnail image of content to a UI corresponding to another external apparatus. The input unit 220 may be implemented as a terminal apparatus such as keyboard, mouse, remote controller, touch screen and a remote control receiving unit.

The display unit 230 may display various UIs according to an external apparatus connected to the display apparatus 100. Herein, the display unit 230 may be implemented in at least one form of a liquid crystal display, a thin film transistor-liquid crystal display (TFT-LCD), an organic light-emitting diode (OLED), a flexible display, and a 3D display. In addition, the display unit 230 may be implemented integrally with the input unit 220, which receives a user operation as it is provided in the form of a touch screen having a mutual layer construction with respect to a touch pad.

Specifically, if a plurality of external apparatuses are connected to the display apparatus 100, the display unit 230 may display a plurality of UIs including the icons of the respective external apparatuses in the image form corresponding to the shape of the respective external apparatuses.

In addition, if a single external apparatus is connected to the display apparatus 100, the display unit 230 may display a UI including the icon of the external apparatus in the image form corresponding to the shape of the external apparatus and a UI including the icon of the display apparatus 100 in the image form corresponding to the shape of the display apparatus 100.

Further, if an icon is selected on a UI, the display unit 230 may display a thumbnail image of the entire content where the selected icon is included.

That is, the display unit 230 may display each shape of the display apparatus 100 and an external apparatus as a UI and various content stored in the display apparatus 100 and an external apparatus such as a moving image, image, text, application, sound data, slide show of a photo, memo, message, and telephone book in the form of an icon and a thumbnail image.

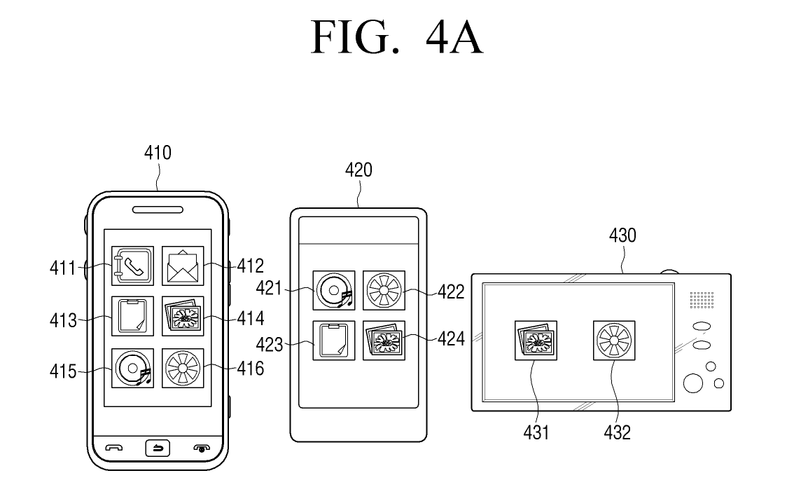

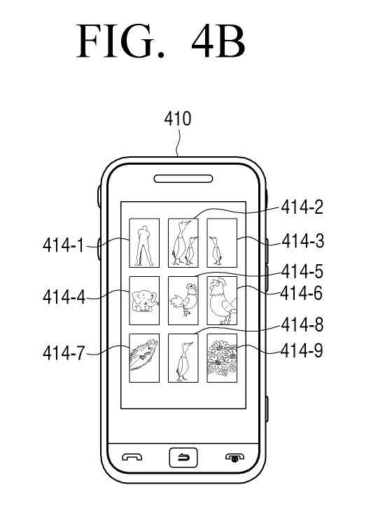

The detailed configuration of UI, icon, and thumbnail image of content displayed by the display unit 230 will be explained in detail with reference to FIGS. 4A and 4B.

The control unit 240 controls the overall operation of each component included in the display apparatus 100. Specifically, the control unit 240 may control the movement of content between a plurality of external apparatuses connected to the display apparatus 100 and editing content stored in the external apparatuses.

To do so, if a plurality of external apparatuses are connected to the display apparatus 100, the control unit may control the display unit 230 to display a plurality of UIs including the icons of each of the external apparatuses in the image form corresponding to the shape of the respective external apparatuses. Herein, the plurality of UIs may be implemented through an emulator program corresponding to the respective external apparatuses, which will be explained in detail later.

In addition, if an icon is selected on one of a plurality of UIs, the control unit 240 may control the display unit 230 to display a thumbnail image corresponding to each of the entire content included in the selected icon on a UI.

Further, if a user operation with respect to a plurality of UIs is input, the control unit 240 may control to move content between a plurality of external apparatuses according to the user operation. Specifically, if an icon is selected in the first UI from among a plurality of Ins and the selected icon is moved to the second UI from among a plurality of UIs, the entire content corresponding to the selected icon may be controlled to move from the first external apparatus corresponding to the first UI to the second external apparatus corresponding to the second UI.

If at least one of thumbnail images displayed on the first UI is selected and moved to the second UI according to a user operation, the control unit 240 may control to move at least one content corresponding to the selected thumbnail image from the first external apparatus corresponding to the first UI to the second external apparatus corresponding to the second UI.

To do so, the control unit 240 may receive at least one content from an external apparatus and control the communication interface unit 210 to transmit the received content to another external apparatus.

In addition, if a thumbnail image corresponding to at least one content is moved from the first external apparatus to the second external apparatus, the control unit 240 may control to display a thumbnail image corresponding to the second external apparatus. To do so, the control unit 240 may transmit a control command to display the moved thumbnail image to the second external apparatus.

Furthermore, if at least one of an icon and a thumbnail image displayed on a UI is edited, the control unit 240 may control to store the edited content in an external apparatus. Specifically, the control unit 240 may transmit a control command to change, modify, add, or delete content corresponding to the icon or thumbnail image, which has been changed, modified, added or deleted, to an external apparatus. In addition, the control unit 240 may display a message notifying a user of content editing on the display unit 230 and on the screen of an external apparatus in the form of an On Screen Display (OSD).

As such, the control unit 240 may control movement of content between a plurality of external apparatuses connected to the display apparatus 100 and editing content stored in an external apparatus. To do so, the control unit 240 may include a conversion unit (not shown) for converting the file size and file format of content, an OSD processing unit (not shown) for displaying a message in the form of OSD, a storage unit (not shown) for storing information regarding the product type and manufacturer of an external apparatus, and etc.

In the description above, only the movement of content between a plurality of external apparatuses connected to the display apparatus 100 has been explained, but this is only an example. If an external apparatus is connected to the display apparatus 100, the movement of content between the display apparatus 100 and the external apparatus may be controlled. Specifically, the display apparatus 100 may display a UI including an icon corresponding to content stored in an external apparatus in the image form corresponding to the shape of the external apparatus and the UI including an icon of the display apparatus 100 in the image form corresponding to the shape of the display apparatus 100. In addition, if a user operation is input on a UI corresponding to an external apparatus and a display apparatus, the display apparatus 100 may control to move content between the external apparatus and the display apparatus according to the user operation.

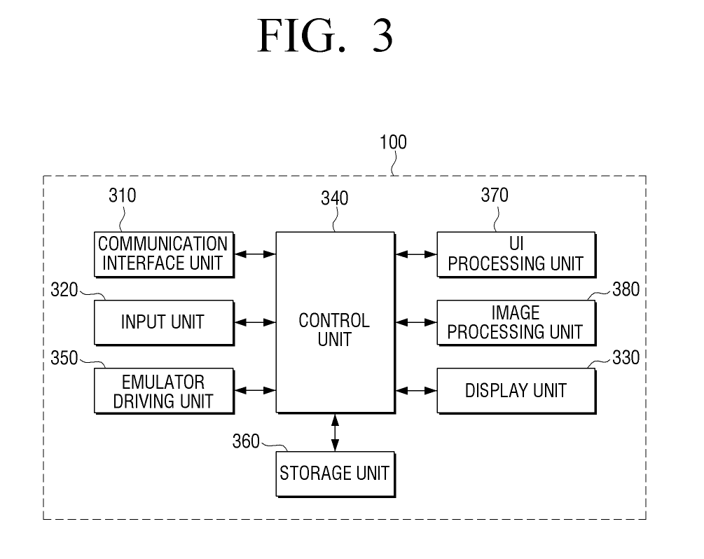

FIG. 3 is a diagram illustrating a structure of the display apparatus 100 in greater detail according to an embodiment of the present invention.

Referring to FIG. 3, the display apparatus 100 comprises a communication interface unit 310, an input unit 320, an emulator driving unit 350, a UI processing unit 370, an image processing unit 380, a display unit 330, a storage unit 360, and a control unit 340. Among the components in FIG. 3, those components that are overlapped with the components in FIG. 2 will not be explained in detail.

The communication interface unit 310 may transmit and receive various content in communication with an external apparatus. To do so, the communication interface unit 310 may communicate with an external apparatus via cable or wirelessly. Here, a wired LAN or a USB may be used for wired communication and a wireless LAN, a Bluetooth®, or a ZigBee may be used for wireless communication.

In addition, the communication interface unit 310 may receive emulator data corresponding to an external apparatus from the external apparatus, which is connected externally.

In some cases, the communication interface unit 310 may receive an emulator program via network.

The input unit 320 receives a user operation to control the display apparatus 100.

Specifically, the input unit 320 may receive a user operation to control a cursor displayed on the display unit 330. A user may select an icon or a thumbnail image of content on the first UI from among a plurality of UIs displayed on the display unit 330 and drag the selected icon or the thumbnail image of content to the second UI using the cursor. In addition, the input unit 320 may receive a user operation to change, modify, add, or delete content corresponding to an icon or a thumbnail image displayed on a UI.

If an external apparatus is connected through the communication interface unit 310, the emulator driving unit 350 drives an emulator corresponding to the connected external apparatus.

Specifically, the emulator driving unit 350 may drive an emulator which can manage content stored in the connected external apparatus in the same way as the corresponding external apparatus does. Here, the emulator may be pre-stored in the storage unit 360 or may be received from the connected external apparatus. Alternatively, the emulator may be installed via network when the external apparatus is connected. Herein, the emulator may be a program capable of moving or editing content stored in the connected external apparatus. For example, the emulator driving unit 350 may drive emulators corresponding to respective external apparatuses based on the received information regarding an external apparatus such as information regarding the product type or manufacturer of the external apparatus.

The UI processing unit 370 may generate various UIs displayed on the display apparatus 100. Specifically, the UI processing unit 370 may generate an emulator corresponding to each external apparatus in the image form corresponding to the shape of the external apparatus respectively. In addition, the UI processing unit 370 may generate an icon corresponding to content stored in each external apparatus and add a UI corresponding to the external apparatus respectively. Herein, the icon may have the same shape as the icon displayed on the external apparatus.

The image processing unit 380 performs signal processing such as video decoding, format analyzing and video scaling with respect to an input or stored image signal. Specifically, the image processing unit 380 may perform signal processing so that various image signals which can be provided by the display apparatus 100 are displayed on the display unit 330.

The display unit 330 displays an image processed by the image processing unit 380 or various UIs generated by the UI processing unit 370.

In particular, if an emulator corresponding to each external apparatus is operated by the emulator driving unit 350 and a UI corresponding to the emulator driven by the UP processing unit 370 is generated, the display unit 330 may display the UI. Specifically, the display unit 330 may display a UI in the image form corresponding to the shape of each external apparatus which includes an icon corresponding to content stored in the external apparatus respectively.

The storage unit 360 is a storage medium storing various programs necessary to operate the display apparatus 100, and may be implemented as a memory, Hard Disk Drive (HDD), and etc. For example, the storage unit may include a ROM to store a program for performing the operation of the control unit 340 and a RAM to temporarily store data for performing the operation of the control unit 340. In addition, the storage unit may further include an EEROM (Electrically Erasable and Programmable ROM) for storing various reference data.

In particular, the storage unit 360 may store various content received from an external apparatus. For example, the storage unit 360 may store content corresponding to content or a thumbnail image which is selected according to a user operation.

In addition, the storage unit 360 may store an emulator program corresponding to various external apparatuses.

The control unit 340 controls overall operation of each component of the display apparatus 100.

In particular, if an external apparatus is connected to the display apparatus 100, the control unit 340 may control the emulator driving unit 350 so that an emulator corresponding to the connected external apparatus is operated. Specifically, the control unit 340 may operate an emulator corresponding to each external apparatus based on the received information regarding an external apparatus such as information regarding the product type or manufacturer of the external apparatus.

If an emulator is operated by the emulator driving unit 350, the control unit 340 may receive and emulator data from a corresponding external apparatus and provide the convert after converting it so that the data can be displayed on the display unit 330. Herein, the emulator data represents data necessary to provide a user with an emulator UI regarding a corresponding external apparatus, and may include content stored in the corresponding external apparatus, content display form, a display form of an icon corresponding to content, and the shape of the corresponding external apparatus.

The UI processing unit 370 may generate converted data in the form of UI and provide it to the display unit 330. Herein, the UI may be a Graphic User Interface (GUI).

Specifically, the UI processing unit 370 may generate an emulator for managing content stored in an external apparatus in the UI form corresponding to the shape of the external apparatus. Here, the UI processing unit 370 may configure a GUI such that a content display form of an external apparatus included in a UI and an icon display form corresponding to content are the same as those in the corresponding external apparatus.

If an emulator corresponding to an external apparatus is displayed in the UI form, the control unit 340 may control to move the corresponding UI between external apparatuses according to a user operation.

Specifically, if a user operation to select an icon or a thumbnail image included in the first UI from among a plurality of UIs displayed on the display unit 330 is input through the input unit 320, the control unit 340 may control to receive the entire content including the corresponding icon or content corresponding to the thumbnail image from the first external apparatus corresponding to the first UI and store the received content in the storage unit 360.

In addition, if a user operation to move an icon or a thumbnail image selected in the first UI to the second UI is input through the input unit 320, the control unit 340 may move the entire content including the corresponding icon or content corresponding to the thumbnail image to the second external apparatus corresponding to the second UI. Herein, the user operation to move the selected icon or thumbnail image may be a drag and drop operation.

The control unit 340 may receive content corresponding to the selected icon or thumbnail image from the first external apparatus and transmit it to the second external apparatus. Alternatively, the control unit 340 may receive content corresponding to the selected icon or thumbnail image from the first external apparatus, store the received content in the storage unit 360 and then transmit the stored content to the second external apparatus.

In addition, the control unit 340 may convert content received from the first external apparatus to correspond to the second external apparatus. Specifically, the control unit 340 may convert the data size (such as, resolution and so on) and data format of photo, video, text file, and etc. received from the first external apparatus to be applicable to the second external apparatus.

In addition, if content corresponding to a selected thumbnail image is moved from the first external apparatus to the second external apparatus, the control unit 340 may control to display a thumbnail image of the corresponding content on the second external apparatus. To do so, the control unit 340 may transmit a control command to display a thumbnail image corresponding to the moved content to the second external apparatus.

For example, if a user selects a photo icon through the first UI displayed on the screen, the control unit 340 may receive content included in the photo icon, that is, a photo file stored in the first external apparatus corresponding to the first UI from the first external apparatus and store the received content in the storage unit 360.

Subsequently, if a user operation of drag and drop the corresponding photo icon to the second UI is performed, the control unit 340 may transmit a photo data pre-stored in the storage unit 360 to the second external apparatus corresponding to the second UI. Here, the control unit 340 may convert the format or the size of the corresponding photo data which is received from the first external apparatus and stored to be in a format or size applicable to the second external apparatus and transmit the converted data.

Afterwards, the control unit 340 may transmit a control command to display the photo data moved to the second external apparatus on the second external apparatus in the form of slide show to the second external apparatus. Accordingly, the second external apparatus displays the moved photo data in the form of slide show.

As described above, the content received from the first external apparatus is stored in the display apparatus 100 and the stored content is transmitted to the second external apparatus, but this is only an example. The display apparatus 100 may not store the content received from the first external apparatus and instead, the display apparatus 100 may transmit the received content to the second external apparatus directly.

In addition, in the description above, an icon or a thumbnail image is moved on a UI through a drag and drop operation, but this is only an example. An icon or a thumbnail image may be moved on a UI through other operations by a user. For example, an input of a predetermined button may perform the above operation.

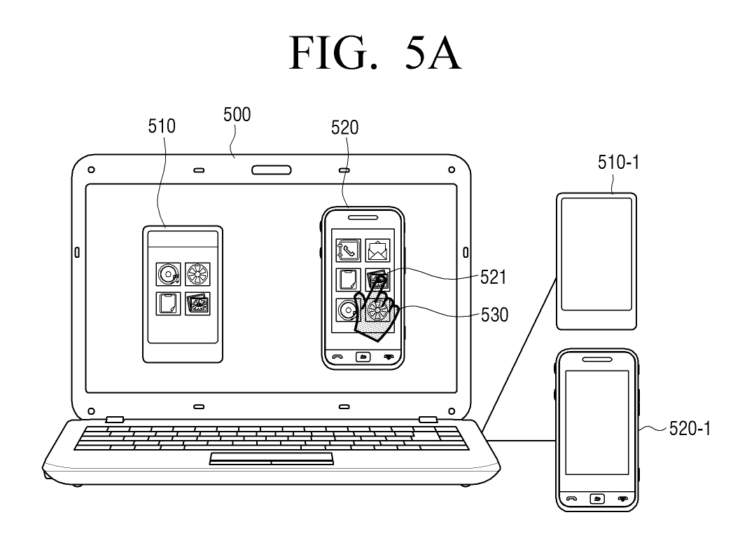

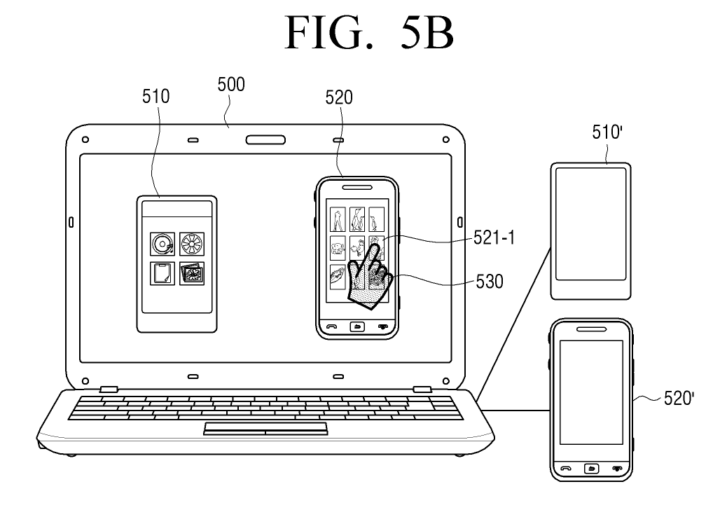

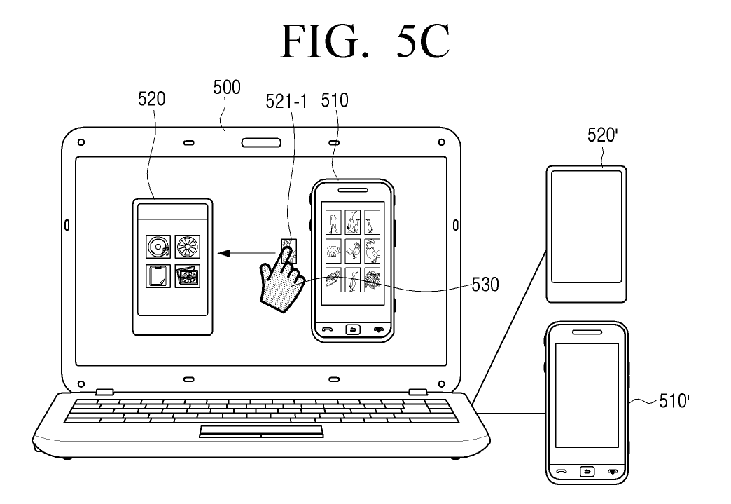

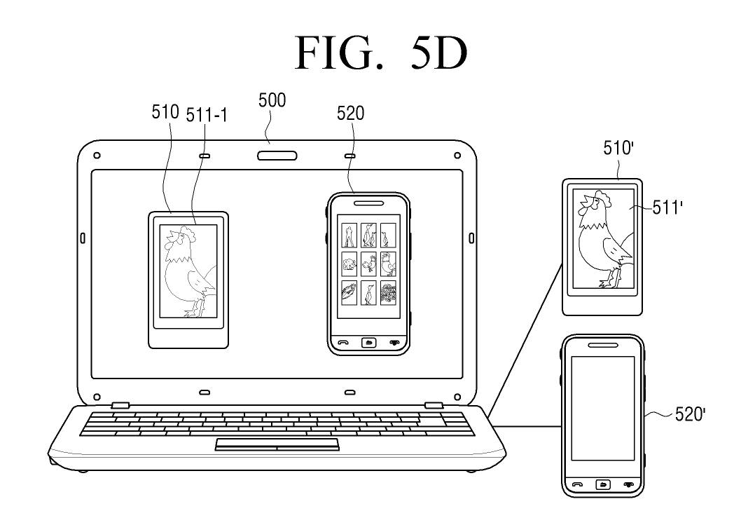

Further, in the description above, the entire content included in an icon displayed on a UI is moved, but this is also only an example. Not only an icon but also each content corresponding to each thumbnail image may be moved. That is, a user may select a thumbnail image regarding one photo file on the first UI and drag and drop the thumbnail image to the second UI so as to move only the photo corresponding to the selected thumbnail image stored in the first external apparatus corresponding to the first UI to the second external apparatus corresponding to the second UI. This will be explained in detailed with reference to FIGS. 5A to 5D.

In addition, if an emulator corresponding to an external apparatus is displayed in the form of UI, the control unit 340 may edit content stored in the external apparatus through a corresponding UI according to a user operation.

For example, if at least one of an icon or a thumbnail image displayed on a UI is edited, the control unit 340 may control to update content stored in an external apparatus corresponding to the UI. Specifically, the control unit 340 may transmit a control command to change, modify, add, or delete content corresponding to an icon or a thumbnail image which has been changed, modified, added, or deleted to an external apparatus.

In addition, the control unit 340 may display a message to notify a user of editing of content on the display unit 330 or on a display screen of an external apparatus in the form of OSD.

For example, if a telephone number included in a telephone book is changed, modified, added, or deleted through a UI displayed on the display unit 330, the control unit 340 may control to change, modify, add, or delete the corresponding telephone number in a corresponding external apparatus, and may display a message showing that the corresponding telephone number is deleted in the form of OSD.

In the embodiment described above, only a telephone number is edited, but only as an example. Various content may be edited through a UI. Specifically, if a corresponding icon or thumbnail image is deleted or added on a UI displayed on the display unit 330, the control unit 340 may control to delete or add the corresponding icon or thumbnail image on a corresponding external apparatus.

For example, if an icon is deleted through a UI displayed on the display unit 330, the control unit 340 may control to delete content included in the deleted icon in a corresponding external apparatus.

FIGS. 4A and 4B are diagrams illustrating a UI displayed on the display apparatus 100 according to an embodiment of the present invention.

FIG. 4A illustrates a UI corresponding to each external apparatus displayed when mobile phone, MP3 player, and digital camera are connected to the display apparatus 100 according to an embodiment of the present invention.

Referring to FIG. 4A, the UI displayed by the display apparatus 100 has an image form corresponding to mobile phone, MP3 player and digital camera, and each UI displays an icon according to content stored in a corresponding external apparatus.

Specifically, a UI 410 corresponding to a mobile phone displays icons representing content stored in the mobile phone such as telephone book, message, memo, photo, music and video (411, 412, 413, 414, 415, 416). Likewise, a UI 420 corresponding to an MP3 player displays icons representing content stored in the MP3 player such as music, video, photo, and text document (421, 422, 423, 424), and a UI 430 corresponding to a digital camera displays icons representing content stored in the digital camera such as photo and video (431, 432). Here, the corresponding icons may represent specific content, but may also represent a group of content including content of a specific category. Hereinafter, the case where a corresponding icon represents a group of content including content of a specific category will be explained for convenience of explanation.

FIG. 4B is a diagram illustrating a case where a specific icon is selected on the UI 410 corresponding to a mobile phone displayed on the display apparatus 100.

Referring to FIG. 4B, if any photo icon 414 is selected on the UI of external device 200 corresponding to a mobile phone, the content included in the selected photo icon 414, that is, a plurality of photos in a photo category are displayed as thumbnail images 414-1 to 414-9.

As described above, the display apparatus 100 displays a UI in the image form corresponding to a connected external apparatus and thus, a user may feel as if he or she interacts with the actual external apparatus. Therefore, the user may manage content easily and more intuitively.

In the embodiment described above, a user selects only an icon including photos and displays the photos in thumbnail images, but only as an example. The present invention is also applicable to other icons. Specifically, if an icon including a video is selected, a thumbnail image regarding one scene of the video may be displayed, and if an icon including music is selected, a thumbnail image photo or album cover of a singer may be displayed.

FIGS. 5A to 5D are diagrams illustrating how content are moved between a display apparatus and an external apparatus according to an embodiment of the present invention.

Referring to FIG. 5A, an MP3 player 510′ and a mobile phone 520′ are connected to the display apparatus 500. Accordingly, a UI 510 corresponding to the MP3 player and a UI 520 corresponding to the mobile phone are displayed on the display apparatus 500.

In addition, the UI 520 corresponding to the mobile phone displays icons including content stored in the mobile phone 520′ and the UI 510 corresponding to the MP3 player displays icons including content stored in the MP3 player 510′.

If a user selects a photo icon 521 from among icons included in the UI 520 corresponding to the mobile phone 520′ using a cursor 530 displayed on the display apparatus 500, the content included in the photo icon 521, that is, a photo stored in the mobile phone 520′ is displayed on the UI 520 corresponding to the mobile phone 520′ in the form of a thumbnail image as illustrated in FIG. 5B. The content include in the icon selected by the user, that is, the photo file stored in the mobile phone 520′ is stored in the display apparatus 500.

If a user wishes to move one photo 521-1 from among photos stored in a mobile phone to the MP3 player 510′, the user may select a thumbnail image 521-1 of a photo to be moved from among a plurality of thumbnail images displayed on the UI 520 corresponding to the mobile phone 520′ and drag the selected thumbnail image to the UI 510 corresponding to the MP3 player 510′ as illustrated in FIG. 5C. Such manipulation by a user may be input using at least one of mouse, keyboard, and touch screen provided on the display apparatus.

If the drag and drop operation regarding the thumbnail image 521-1 to the UI 510 corresponding to the MP3 player is completed by the user operation, the moved thumbnail image 511-1 is displayed on the UI 510 corresponding to the MP3 player 510′ and the photo file 521-1 stored in the display apparatus 500 is copied and moved to the MP3 player 510′ as illustrated in FIG. 5D. Subsequently, the image 511′ regarding the photo file moved to the MP3 player 510′ is displayed on the MP3 player according to a control command of the display apparatus.

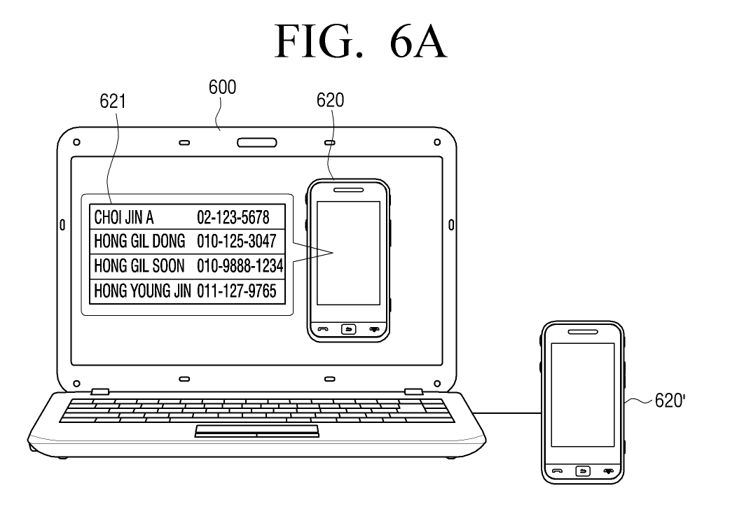

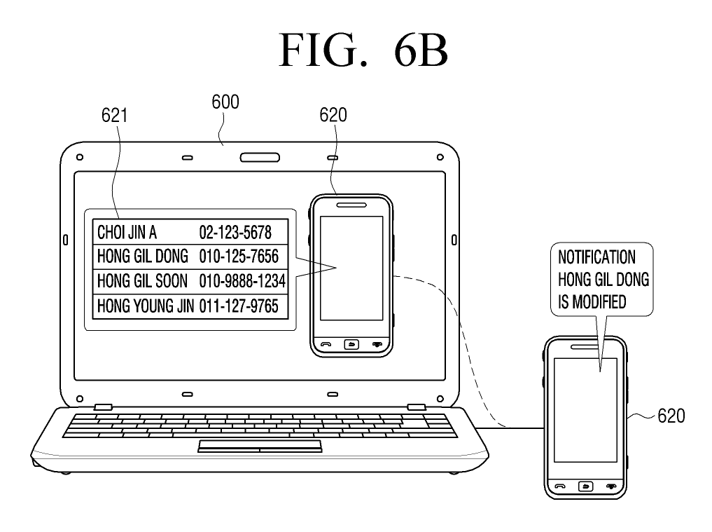

FIGS. 6A and 6B are diagrams illustrating a method through which a display apparatus edits content stored in an external apparatus according to an embodiment of the present invention.

Referring to FIG. 6A, the mobile phone 520′ is connected to the display apparatus 600 and accordingly, the UI corresponding to the mobile phone 520′ is displayed on the display apparatus 600. Herein, the UI 520 corresponding to the mobile phone 520′ may display a telephone book 621 stored in the mobile phone 520′ according to user operation (of selecting a telephone book icon).

If a user changes a telephone number included in the telephone book 621 through the UI 520 displayed on the display apparatus 600 as illustrated in FIG. 6B, a corresponding telephone number stored in the mobile phone 520′ may be changed simultaneously. For example, if a user changes the telephone number of Hong Gil Dong from “010-125-3047” to “010-125-7656” through the UI 520 corresponding to the mobile phone 520′, the corresponding telephone number stored in the mobile phone 520′ may also be changed simultaneously. Here, a message notifying the user of the change of the corresponding telephone number stored in the mobile phone 520′ may be displayed on the screen of the mobile phone 520′.

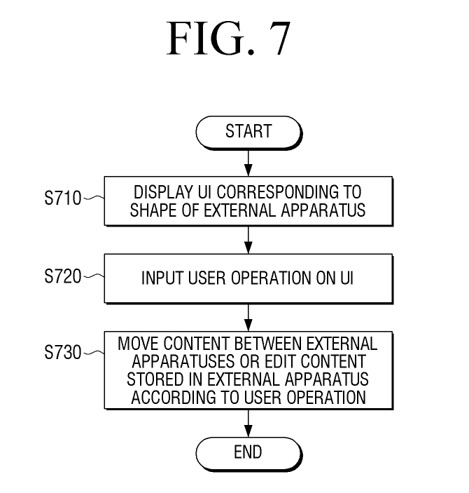

FIG. 7 is a flowchart illustrating a method for managing content of an external apparatus according to an embodiment of the present invention.

First, if a plurality of external apparatuses are connected, UIs corresponding to each of the external apparatuses are displayed in step S710. Here, each UI represents a UI regarding the emulator of the external apparatuses and displays content and an icon corresponding to the content in the same way as the external apparatuses do.

Subsequently, a user operation is input on a UI in step S720. Such an operation by a user may be selecting an icon included in the first UI from among a plurality of UIs and performing a drag and drop operation of the icon to the second UI from among the plurality of UIs. The user operation may also represent an operation of editing, that is, changing, modifying, adding, or deleting at least one icon or thumbnail image displayed on the UI.

According to the user operation, content is moved between external apparatuses or content stored in an external apparatus is edited in step S730. Specifically, based on a command to select an icon in on the first UI from among a plurality of UIs and move the selected icon to the second UI from among the plurality of UIs, the entire content corresponding to the selected icon may be moved from the first external apparatus corresponding to the first UI to the second external apparatus corresponding to the second UI. In addition, based on a command to edit at least one of an icon and a thumbnail image displayed on a UI, the corresponding editing may be stored in an external apparatus.

In step S720, if an icon is selected from the first UI from among a plurality of UIs, the thumbnail image of the entire content included in the icon selected from the first UI may be displayed.

In step S730, based on a user command to select at least one of thumbnail images and move the selected thumbnail image to the second UI from among the plurality of UIs, the entire content corresponding to the selected thumbnail image may be moved from the first external apparatus corresponding to the first UI to the second external apparatus corresponding to the second UI.

In addition, a thumbnail image corresponding to the at least one content moved to the second external apparatus may be displayed on the second external apparatus.

In step S720, if an icon included in the first UI from among a plurality of UIs is selected according to a user operation, the entire content corresponding to the selected icon may be stored.

If an icon is selected in the first UI from among a plurality of UIs and moved to the second UI from among the plurality of UIs, the stored content may be moved to the second external apparatus corresponding to the second UI.

In addition, a message notifying a user that content has been edited may be displayed on the external apparatus.

Accordingly, a user may easily and more intuitively recognize which external apparatus content is moved.

In the embodiment described above, content is moved between external apparatuses as one example. Content may also be moved between an external apparatus and a display apparatus.

Specifically, if an external apparatus is connected, the first UI including an icon of the external apparatus may be displayed in the image form corresponding to the shape of the external apparatus and the second UI including an icon of the display apparatus may be displayed in the image form corresponding to the shape of the display apparatus.

Subsequently, if a user operation is provided on the first and second UIs, content may be moved between the external apparatus and the display apparatus according to the user operation.

The above-described method may be implemented by a display apparatus according to an embodiment of the present invention or a different display apparatus which may not have every component of the present display apparatus.

The present invention may include a computer reading and recording medium having a program for performing the above method for display an image. The computer reading and recording medium includes various types of recording apparatuses which store data readable by a computer system. Examples of computer reading and recording media include a ROM, a RAM, a CD-ROM, a magnetic tape, a floppy disk, and an optical data storing apparatus. The computer reading and recording medium is distributed to a computer system connected through a network, and a code readable by a computer through a distribution method may be stored and performed.

While the present invention has been shown and described with reference to various embodiments thereof, various changes in form and detail may be made without departing from the scope and spirit of the present invention, defined by the appended claims.

What is claimed is:

1. A method for managing content using a display apparatus, the method comprising:
if a plurality of external apparatuses are connected to the display apparatus, displaying a plurality of UIs including an icon of respective external apparatuses in an image form corresponding to a shape of respective external apparatuses; and
if a user operation is performed on the plurality of UIs, moving content between the plurality of external apparatuses according to the user operation.

2. The method as claimed in claim 1, wherein the user operation includes a drag and drop operation to select an icon included in a first UI from among the plurality of UIs and to move the selected icon to a second UI from among the plurality of UIs.

3. The method as claimed in claim 1, wherein moving the content comprises:
if an icon is selected in a first UI from among the plurality of UIs and moved to a second UI from among the plurality of UIs, moving content corresponding to the selected icon from a first external apparatus corresponding to the first UI to a second external apparatus corresponding to the second UI.

4. The method as claimed in claim 1, wherein moving the content comprises:
if an icon is selected in a first UI from among the plurality of UIs, displaying thumbnail images of content included in the icon selected in the first UI; and
if at least one of the thumbnail images is selected and moved to a second UI from among the plurality of UIs, moving at least one content corresponding to the selected at least one thumbnail image from a first external apparatus corresponding to the first UI to a second external apparatus corresponding to the second UI.

5. The method as claimed in claim 4, further comprising:
displaying a thumbnail image corresponding to at least one content moved to the second external apparatus on the second external apparatus.

6. The method as claimed in claim 1, further comprising:
if an icon included in a first UI from among the plurality of UIs is selected according to a user operation, storing content corresponding to the selected icon.

7. The method as claimed in claim 6, wherein moving the content comprises:
if an icon is selected in a first UI from among the plurality of UIs and moved to a second UI from among the plurality of UIs, moving the stored content to a second external apparatus corresponding to the second UI.

8. The method as claimed in claim 1, further comprising:
if content included in an icon on a first UI from among the plurality of UIs is edited, storing the edited content in a first external apparatus corresponding to the first UI.

9. The method as claimed in claim 8, further comprising:
displaying a message notifying a user that the content on the first external apparatus is edited.

10. The method as claimed in claim 1, further comprising:
if one external apparatus is connected to the display apparatus, displaying a first UI including an icon of the external apparatus in an image form corresponding to a shape of the external apparatus and displaying a second UI including an icon of the display apparatus in an image form corresponding to a shape of the display apparatus; and
if a user operation is performed on the first and the second UIs, moving content between the external apparatus and the display apparatus according to the user operation.

11. A display apparatus, comprising:
a communication interface unit which is connected to at least one external apparatus and transmits and receives content;
a display unit which, if a plurality of external apparatuses are connected to the interface, displaying a plurality of UIs including icons of respective external apparatuses in an image form corresponding to shapes of respective external apparatuses;
an input unit which receives a user operation; and
a control unit which, if a user operation regarding the plurality of UIs is input, controls to move content between the plurality of external apparatuses according to the user operation.

12. The display apparatus as claimed in claim 11, wherein the user operation includes an operation to select an icon included in a first UI from among the plurality of UIs and drag and drop the selected icon to a second UI from among the plurality of UIs.

13. The display apparatus as claimed in claim 11, wherein the control unit, if an icon is selected is selected in a first UI from among the plurality of UIs and moved to a second UI from among the plurality of UIs, controls to move content corresponding to the selected icon from a first external apparatus corresponding to the first UI to a second external apparatus corresponding to the second UI.

14. The display apparatus as claimed in claim 11, wherein the control unit, if an icon is selected in a first UI from among the plurality of UIs, controls to display thumbnail images of content included in the icon selected in the first UI on the display unit, and if at least one of the thumbnail images is selected and moved to a second UI from among the plurality of UIs, controls to move at least one content corresponding to the selected at least one thumbnail image from a first external apparatus corresponding to the first UI to a second external apparatus corresponding to the second UI.

15. The display apparatus as claimed in claim 14, wherein the control unit controls to display a thumbnail image corresponding to the at least one content moved to the second external apparatus on the second external apparatus.

16. The display apparatus as claimed in claim 11, further comprising:
a storage unit which stores content received from at least one external apparatus connected to the interface,
wherein the control unit, if an icon included in a first UI from among the plurality of UIs is selected according to a user operation, stores content corresponding to the selected icon in the storage unit.

17. The display apparatus as claimed in claim 16, wherein the control unit, if an icon is selected in a first UI from among the plurality of UIs and moved to a second UI from among the plurality of UIs, controls to move content stored in the storage unit to a second external apparatus corresponding to the second UI.

18. The display apparatus as claimed in claim 11, wherein the control unit, if the content included in an icon in a first UI from among the plurality of UIs is edited, controls to store the edited content in a first external apparatus corresponding to the first UI.

19. The display apparatus as claimed in claim 18, wherein the control unit controls to display a message notifying a user that content editing is performed on the first external apparatus.

20. The display apparatus as claimed in claim 11, wherein the display unit, if one external apparatus is connected to the display apparatus, displays a first UI including an icon of the external apparatus in an image form corresponding to a shape of the external apparatus and displays a second UI including an icon of the display apparatus in an image form corresponding to a shape of the display apparatus,
wherein the control unit, if a user operation is performed on the first and the second UIs, controls to move content between the external apparatus and the display apparatus according to the user operation.
